(19) United States
(12) Patent Application Publication
(10) Pub. No.: US 2011/0005472 A1
(43) Pub. Date: Jan. 13, 2011

(54) VEHICLE ENGINE

(76) Inventor: Martin Larsson, Valberg (SE)

Correspondence Address: HARNESS, DICKEY & PIERCE, P.L.C., P.O. BOX 8910, RESTON, VA, 20195, US

(21) Appl. No.: 12/311,890

(22) PCT Filed: Oct. 17, 2007
(86) PCT No.: PCT/SE2007/000913

§ 371 Date: Sep. 23, 2010

(30) Foreign Application Priority Data
Oct. 18, 2006 (SE) 0602202-4

(51) Int. Cl. F02B 63/00; F02G 1/04

(52) U.S. Cl. 123/2; 60/524

(57) ABSTRACT

The present invention relates to A vehicle engine (100) comprising a combustion part (110), a heat engine (120) and an electrical generator (130). The combustion part (110) comprises a pellet burning unit, which is arranged to generate heat by burning pellets, said pellet burning unit is connected to said heat engine (120), which heat engine is arranged to convert heat from said pellet burning unit to kinetic energy, said electrical generator is arranged to convert said kinetic energy from said heat engine to generate electrical energy for actuating wheels of said vehicle.

### TECHNICAL FIELD

The present invention relates to an enhanced vehicle engine system and in particular to a vehicle engine using pellet or similar energy sources.

### BACKGROUND OF THE INVENTION

High costs for fossil fuels and environmental demands force new innovative solutions for substituting combustion engines.

Car manufacturers invest huge resources on developing new environmentally friendly engines. There are more and more hybrid-engines developed and vehicles equipped with such hybrid-engines are sold. Nearly all hybrids still require gasoline and diesel as their sole fuel source though other fuels such as ethanol or plant based oils have also seen occasional use. A number of other hybrid vehicles use hydrogen fuel.

Wood pellets are a type of wood fuel, generally made from compacted sawdust. They are usually produced as a byproduct of sawmilling and other wood transformation activities. The pellets are extremely dense and can be produced with a low humidity content (below 10%) that allows them to be burned with a very high combustion efficiency. Further, their regular geometry and small size allow automatic feeding with very fine calibration. They can be fed to a burner by auger feeding or by pneumatic conveying.

Their high density also permits compact storage and rational transport over long distance. They can be conveniently blown from a tanker to a storage space.

Pellet combustion contributes the same amount of carbon dioxide as trees use under their growth. Thus, the pellets are part of eco-cycle while other fuels generate new carbon dioxide to the environment.

DE 101 53 86 relates to treatment of liquid manure and poultry feces, which pelletizes and dries the manure to 95-100% dry substance. The plant for treating liquid manure, comprises a liquid manure reservoir suction pump, flocculation plant, flocculant dosing pump, pre-dewatering cylinder, pre-thickening cylinder, travelling screen press, mixing screw, pelletizing machine, etc. The pellets are used as energy source in a pellet burner for running a Sterling engine to produce electrical energy.

U.S. Pat. No. 5,711,232 relates to a Stirling engine with an external combustion chamber for burning a kerosene and transferring a high temperature therein to working fluid in heater tubes. The external combustion chamber is connected to a furnace for burning industrial waste materials such as plastic materials or rubber materials so that the high temperature above 900 DEG C is able to be supplied to the combustion chamber. This serves in raising an output power of the Stirling engine. A conduit for connecting the furnace with the combustion chamber is provided with a dumper capable of interrupting a flow of the high temperature combustion gases toward the combustion chamber of the Stirling engine.

In U.S. Pat. No. 4,945,837 a stoker assembly for a solid particulate burning stove is described including a fuel directing flange for directing the fuel to an upper combustion plate and ventilation tubes to prevent the ignition and combustion of fuel stored in remote bins. The fuel directing flange serves to prevent the solid particulate fuel from falling back into the auger conveyor and being ground into smaller particulate matter.

None of the above documents relate to hybrid engine for driving a vehicle.

### SUMMARY OF THE INVENTION

The present invention relates to an enhanced engine type for vehicles with need for an environmentally friendly engine. The advantageous with an engine according to the present invention involve for example:
1. Use of standard pellets
2. No net displacement of carbon dioxide, which does not contribute to green-house effect,
3. Low emission of nitrogen and sulphur, which does not contribute to acidification,
4. Ecocycle adapt, the waste can be returned to the nature,
5. Renewable sources of energy,
6. Need of small help energy for production.

For these reasons, the invention relates to a vehicle engine comprising a combustion part, a heat engine and an electrical generator. The combustion part comprises a pellet burning unit, which is arranged to generate heat by burning pellets, the pellet burning unit is connected to the heat engine, which heat engine is arranged to convert heat from the pellet burning unit to kinetic energy, the electrical generator is arranged to convert the kinetic energy from the heat engine to generate electrical energy for actuating wheels of he vehicle.

Most preferably, the heat engine is a Stirling engine. Preferably, the electrical generator is an induction generator. Preferably, the pellet burning unit comprises: a combustion chamber having a combustion zone; an transporting unit for providing fuel pellets to be burned in the combustion zone; a burner holding fuel to be burned in the combustion zone; a pressure regulator providing air to the combustion zone; an exhaust system for removing combustion gases from the combustion chamber; and optionally a blower for directing air past the exhaust system and into a space to be heated.

The invention also relates to a vehicle comprising an electrical motor and a power generating engine, said power generating engine comprising a combustion part, a heat engine and an electrical generator. The combustion part comprises a pellet burning unit, which is arranged to generate heat by burning pellets, the pellet burning unit is connected to the heat engine, which heat engine is arranged to convert heat from the pellet burning unit to kinetic energy, the electrical generator is arranged to convert the kinetic energy from the heat engine to generate electrical energy for actuating wheels of the vehicle. Most preferably the heat engine is a Stirling engine. Preferably, the electrical generator is an induction generator. The vehicle further comprises a particulate filter system connected to an exhaust pipe and may comprise an arrangement for producing pellets onboard.

### BRIEF DESCRIPTION OF THE DRAWINGS

The invention will be described in more detail with reference to the attached drawings, illustrating exemplary embodiments of the invention:

FIG. 1 illustrates schematically parts of an engine system according to one embodiment of the present invention,

FIG. 2 illustrates an exemplary embodiment of a heat generating unit according to the invention,

FIG. 3 illustrates a pellet manufacturing arrangement,

FIG. 4 is a block diagram over the invention, and

FIGS. 5a and 5b are two exemplary methods of assembly an engine according to the present invention.

### DETAILED DESCRIPTION OF PREFERRED EMBODIMENTS

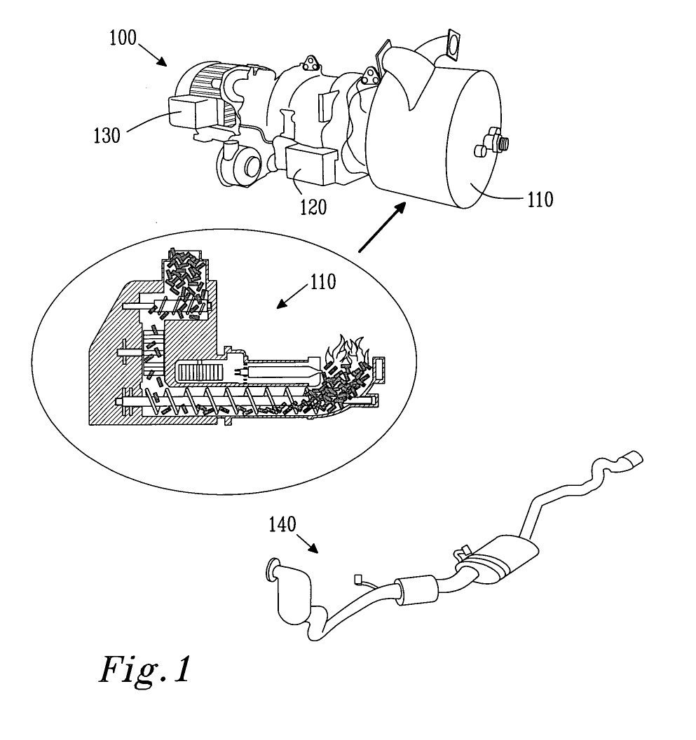

FIG. 1 illustrates parts of an engine according to one embodiment of the present invention. The engine 100 comprises an external heating system 110 cooperating with a heat engine 120 connected to an electrical generator 130.

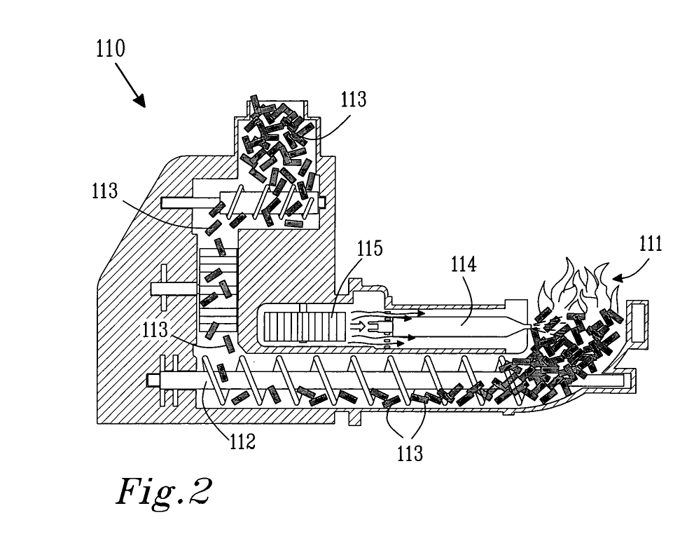

According to one exemplary embodiment of the invention the external heating system comprises a pellet combustion or burning heating unit 110. A pellet burning heating unit 110 according to this example, as illustrated in FIG. 2, comprises: a combustion chamber having a combustion zone 111; a transporting unit 112 for providing fuel pellets 113 to be burned in the combustion zone; a burner 114 holding fuel to be burned in the combustion zone; a pressure regulator (or fan) 115 providing air to the combustion zone; an exhaust system (not shown) for removing combustion gases from the combustion chamber; and optionally a blower (not shown) for directing air past the exhaust system and into a space to be heated.

Obviously, other types of pellet burning units having other constructional structures may be used.

Returning now to FIG. 1, the engine system of the present invention further comprises a particulate filter system 140 connected to the exhaust pipe of a vehicle. A Particulate Filter is a device designed to remove particulate matter or soot from the exhaust gas of the engine. A pellet-powered vehicle with a filter installed will emit no visible smoke from its exhaust pipe.

In addition to collecting the particulate, a method must be designed to get rid of it. Some filters are single use (disposable), while others are designed to bum off the accumulated particulate, either through the use of a catalyst (passive), or through an active technology, such as a fuel burner which heats the filter to soot combustion temperatures, or through engine modifications (the engine is set to run a certain specific way when the filter load reaches a pre-determined level, either to heat the exhaust gasses, or to produce high amounts of NO2, which will oxidize the particulates at relatively low temperatures). This procedure is known as “filter regeneration.”

As mentioned earlier, the external heating system is arranged to drive a heat engine, such as a Sterling engine. The heat engine has a fixed quantity of gaseous working medium, (high-pressure hydrogen), that is contained and enclosed within each cylinder in the heat engine. A portion of the engine is maintained at a constant high temperature by burning pellets fuels in the combustor and transferring heat to the hydrogen via heater tubes. The other portion of the engine is maintained at a constant low temperature by circulating the hydrogen through coolers. The working gas is transferred back and forth between the hot and cold portions of the engine and alternately expanded and compressed by the movement of the engine's pistons.

The pistons movements are then transformed to a rotational movement (kinetic energy) rotating the driving shaft of the generator 130. Preferably, induction generator may be used. However, the generator may be any type generating sufficient electrical energy.

A heat engine can provide 2-5000 kW (kWe) of continuous electrical power. The heat engine uses 50% fewer moving parts than a combustion engine with a fraction of the emissions and maintenance requirements.

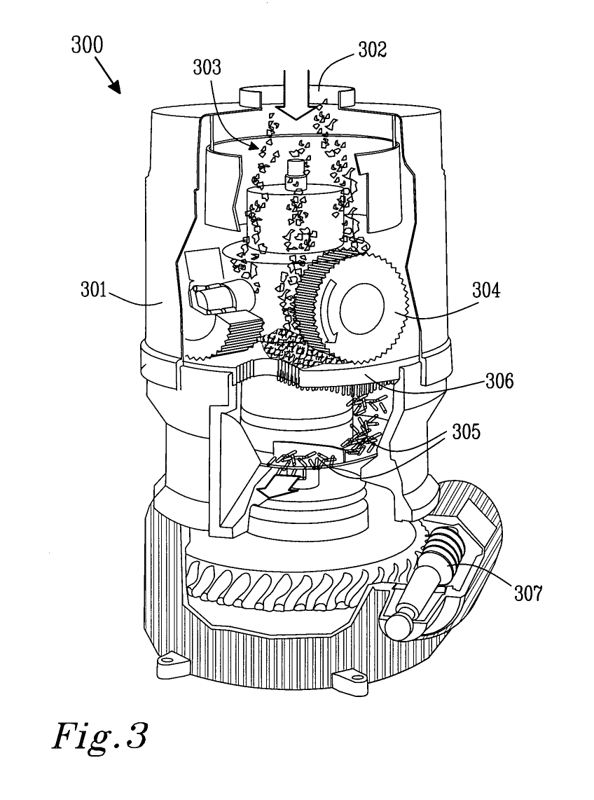

If the engine of the invention is mounted in a vehicle, the vehicle will be provided with a storage space for either pellets or material for making pellets, such as wood shavings, wooed chips, sawdust, or any other combustible material. FIG. 3 illustrates a pellet making arrangement 300 which can be arranged onboard a vehicle or at a refilling station. The pellet maker 300 comprises a housing 301, having an opening 302 for receiving, e.g. wood chips 303, which are guided to compressing rollers 304, which presses the chips into pellets 305 through a mould 306. The prepared pellets are then transported out of the arrangement through another opening. The arrangement is driven by means of an electrical motor 307.

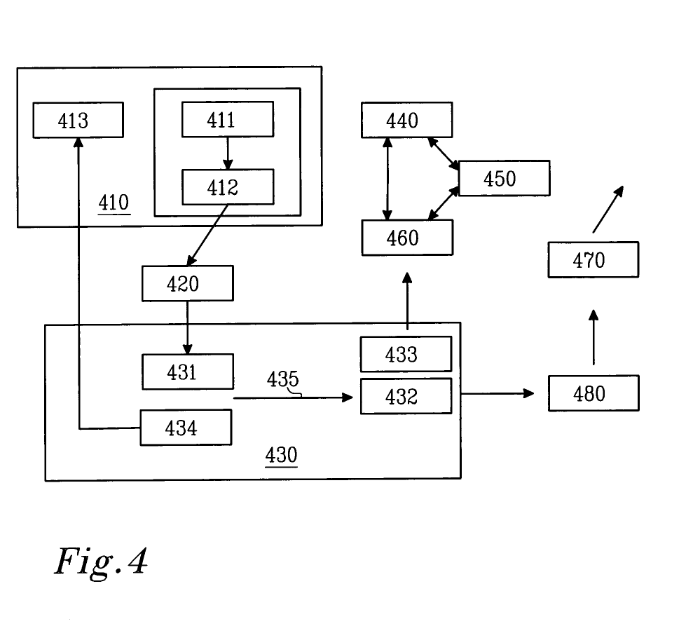

FIG. 4 illustrates a block diagram over the system of the invention. The system comprises a storage space 410, comprising a tank 411 for storing pellets, a receiver 412 for receiving pellets from the tank 411 and a cleaning arrangement 413 for receiving burn waste (ash) from the pellet burner.

A conveyer system 420 transports the pellets from the tank to the burner. The system may be a spiral transporter, vacuum or blower, etc.

The engine part 430 comprises the pellet burner 431, heat engine 432, generator 433, and collection place 434 for collecting as from the pellet burner. Heat 435 from the burner activates the heat engine which drives the generator.

The generator produces electricity which is fed to an electrical motor 440. Control electronics 460 control the operation of the motor and charging of batteries 450.

The exhausts from the engine part are transported to the exhaust pipe 460 after being filtered in the particulate filter system 480.

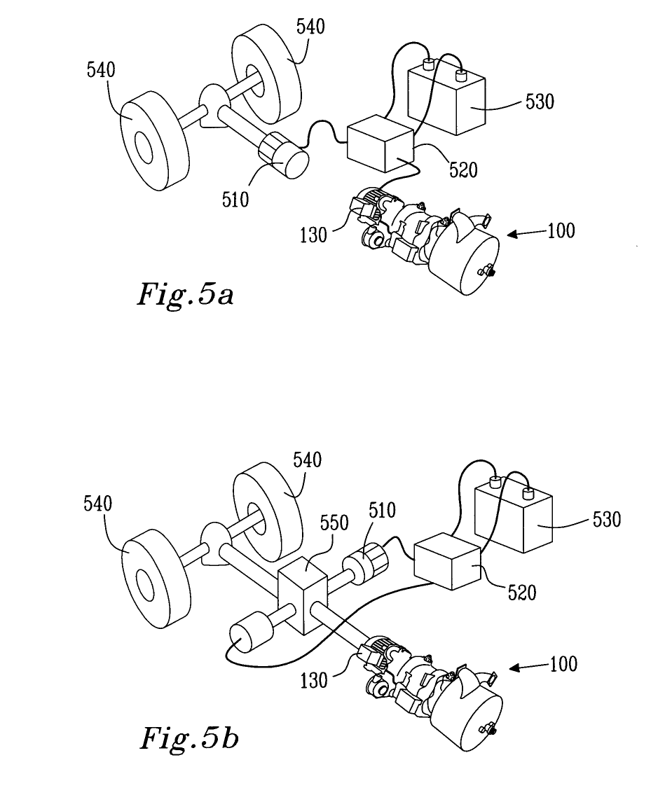

The engine according to the invention may be assembled in serial or parallel as illustrated in FIGS. 5a and 5b. FIG. 5a illustrates the engine 100 according to the present invention serially arranged with the electrical motor 510. The electrical power generated by the generator 130 is fed to the electrical motor 510 through control electronics 520. The control electronics 520 may also control the recharging of the battery module 530. The power input to the electrical motor is used to rotate the vehicle wheels 540.

In the parallel assembled engine, as illustrated in FIG. 5b, the electrical generator 130 is not directly connected to the engine 100. A gearbox 550 is used to transfer the rotation from the heat engine to the generator. In this embodiment, the heat engine may also be used to drive the wheels 540. Otherwise, the function is similar to the previous example.

The invention is not limited to the described and illustrated embodiments. It can be modified and altered in a number of ways within the scope of the attached claims. Specially, the pellets used may be wooden, or of any other suitable material. The pellets may be formed in any way in different shapes suited for the burner.

1. A vehicle engine comprising a combustion part, a heat engine and an electrical generator, wherein
said combustion part comprises a pellet burning unit, which is arranged to generate heat by burning pellets, said pellet burning unit is connected to said heat engine, which heat engine is arranged to convert heat from said pellet burning unit to kinetic energy, said electrical generator is arranged to convert said kinetic energy from said heat engine to generate electrical energy for directly or indirectly actuating wheels of said vehicle.

2. The engine of claim 1, wherein said heat engine is a Stirling engine.

3. The engine of claim 1, wherein said electrical generator is an induction generator.

4. The engine of claim 1, wherein said pellet burning unit comprises: a combustion chamber having a combustion zone; an transporting unit for providing fuel pellets to be burned in the combustion zone; a burner holding fuel to be burned in the combustion zone; a pressure regulator providing air to the combustion zone; an exhaust system for removing combustion gases from the combustion chamber; and optionally a blower for directing air past the exhaust system and into a space to be heated.

5. The engine of according to claim 1, wherein said pellets are made of any of wood shavings, wood chips or sawdust.

6. A vehicle comprising an electrical motor and a power generating engine, said power generating engine comprising a combustion part, a heat engine and a generator for generating electrical power, wherein
said combustion part is pellet burning unit, which is arranged to generate heat by burning pellets, said pellet burning unit is connected to said heat engine, which heat engine is arranged to convert heat from said pellet burning unit to kinetic energy, said electrical generator is arranged to convert said kinetic energy from said heat engine to generate electrical energy for actuating directly or indirectly wheels of said vehicle.

7. The vehicle of claim 6, wherein said heat engine is a Stirling engine.

8. The vehicle of claim 6, wherein said electrical generator is an induction generator.

9. The vehicle of claim 6, further comprising a particulate filter system connected to an exhaust pipe.

10. The vehicle of claim 6, further comprising an arrangement for producing pellets onboard.

11. The vehicle of claim 6, further comprising a battery set up rechargeable by said electrical energy.

12. The vehicle of claim 6, further comprising an electrical output.

13. A method of driving a vehicle, the method comprising burning pellets in a pellet burner, converting heat from said pellet burner to kinetic energy by means of a heat engine, using said kinetic energy to generate electrical energy by means of generator, using said electrical energy directly or indirectly to actuate wheels of said vehicle.
